(19) United States
(12) Patent Application Publication
(10) Pub. No.: US 2025/0078570 A1
(43) Pub. Date: Mar. 6, 2025

(54) EXPRESSION DRIVING METHOD AND DEVICE, AND EXPRESSION DRIVING MODEL TRAINING METHOD AND DEVICE

(71) Applicant: Lemon Inc., Grand Cayman (KY)

(72) Inventors: Yizhe ZHU, Los Angeles, CA (US); Xiao YANG, Los Angeles, CA (US); Jianwei LI, Los Angeles, CA (US); Xiaohui SHEN, Los Angeles, CA (US)

(21) Appl. No.: 18/726,709

(22) PCT Filed: Jan. 4, 2023
(86) PCT No.: PCT/SG2023/050004

§ 371 Date: Jul. 3, 2024

(30) Foreign Application Priority Data
Jan. 4, 2022 (CN) 202210001031.3

(51) Int. Cl. G06V 40/16; G06V 10/46; G06V 10/82

(52) U.S. Cl. CPC G06V 40/174; G06V 10/467; G06V 10/82; G06V 40/171

(57) ABSTRACT

The present disclosure provides an expression driving method and apparatus, and a training method and apparatus of an expression driving model. The expression driving method includes acquiring a first video; and inputting the first video into a pre-trained expression driving model to obtain a second video. The expression driving model is trained based on a target sample image and a plurality of first sample images. A facial image in the second video is generated based on the target sample image. A gesture expression feature of the facial image in the second video is the same as a gesture expression feature of a facial image in the first video.

### CROSS-REFERENCE TO RELATED APPLICATION

The present disclosure claims priority to Chinese Patent Application No. 202210001031.3, filed on Jan. 4, 2022, entitled “Expression driving method and model training method”, which is incorporated herein by reference in its entirety.

### TECHNICAL FIELD

The present disclosure relates to the technical field of character driving, and in particular, to an expression driving method and apparatus, a training method and apparatus of an expression driving model, an electronic device, a computer-readable storage medium, a computer program product, and a computer program.

### BACKGROUND

The character-image driving refers to driving a static character-image based on the provided driving information (e.g., human gestures, facial expressions, etc.) so that the static character-image can move realistically.

In the related art, it is common to process a driving video using a generative adversarial network model to obtain driving information, and to drive the static character image with the driving information, thereby generating a new video.

In the related art, in obtaining the new video with the generative adversarial network model, since the generative adversarial network model requires a large amount of data computation, the real-time property of the new video is poor.

### SUMMARY

The present disclosure provides an expression driving method and apparatus, a training method and apparatus of an expression driving model, an electronic device, a computer-readable storage medium, a computer program product, and a computer program, to solve the problem of poor real-time of the new video.

In a first aspect, the present disclosure provides an expression driving method, including:
acquiring a first video; and
inputting the first video into a pre-trained expression driving model to obtain a second video; wherein the expression driving model is trained based on a target sample image and a plurality of first sample images, wherein a facial image in the second video is generated based on the target sample image, and wherein a gesture expression feature of the facial image in the second video is the same as a gesture expression feature of a facial image in the first video.

In some embodiments, the expression driving model is trained based on a plurality of sample image pairs determined based on the plurality of first sample images and corresponding second sample images;
a second sample image is derived based on a plurality of target facial keypoints in the target sample image and a plurality of first facial keypoints in a corresponding first sample image; and
a similarity between a gesture expression feature of a facial image in the second sample image and a gesture expression feature of a facial image in the corresponding first sample image is greater than a preset value.

In some embodiments, the second sample image is obtained based on displacement information between the plurality of target facial keypoints and the plurality of first facial keypoints and a corresponding facial feature map of the target sample image;
for each target facial keypoint, the displacement information is displacement information between the target facial keypoint and a corresponding first facial keypoint; and
the facial feature map is obtained by encoding facial information of the target sample image.

In some embodiments, the displacement information is determined according to difference information between the plurality of target facial keypoints and corresponding first facial keypoints, and a pre-trained network model.

In some embodiments, the difference information is determined according to coordinate information of the target facial keypoint and coordinate information of the corresponding first facial keypoint under a same coordinate system.

In some embodiments, the plurality of first sample images are initial sample images in which a number of sample images for each gesture angle conforms to a predetermined distribution.

In a second aspect, the present disclosure provides a training method of an expression driving model, including:
extracting a plurality of target facial keypoints in a target sample image, and a plurality of first facial keypoints in each of a plurality of first sample images, respectively;
determining, for each first sample image and each target facial keypoint, displacement information between a target facial keypoint and a first facial keypoint in the first sample image corresponding to the target facial keypoint;
generating a second sample image according to the displacement information and the target sample image; wherein a similarity between a gesture expression feature of a facial image in the second sample image and a gesture expression feature of a facial image in the target sample image is greater than a preset value;
determining a plurality of sample image pairs according to the plurality of first sample images and corresponding second sample images; and
updating model parameters of an initial expression driving model according to the plurality of sample image pairs to obtain the expression driving model.

In some embodiments, the generating the second sample image according to the displacement information and the target sample image includes:
encoding facial information in the target sample image to obtain a facial feature map; and
determining the second sample image according to the displacement information and the facial feature map.

In some embodiments, the determining the second sample image according to the displacement information and the facial feature map includes:
performing, according to the displacement information, bending transition processing and/or displacement processing on the facial feature map to obtain a processed facial feature map; and
decoding the processed facial feature map to obtain the second sample image.

In some embodiments, the determining displacement information between the target facial keypoint and the first facial keypoint in the first sample image corresponding to the target facial keypoint includes:
determining difference information between the target facial keypoints and first facial keypoints in the first sample image corresponding to the target facial keypoints; and
determining the displacement information according to the difference information and a pre-trained network model.

In some embodiments, the determining the difference information between the target facial keypoints and first facial keypoints in the first sample image corresponding to the target facial keypoints includes:
transforming the plurality of target facial keypoints and the plurality of first facial keypoints into a same coordinate system; and
determining the difference information between a respective target facial keypoints and a corresponding first facial keypoints according to coordinate information of the respective target facial keypoints and the coordinate information of the corresponding first facial keypoints under the same coordinate system.

In some embodiments, the method further includes:
acquiring a plurality of initial sample images;
determining gesture angles of the plurality of initial sample images; and
determining initial sample images in which a number of sample images for each gesture angle conforms to a predetermined distribution as the plurality of first sample images.

In a third aspect, the present disclosure provides an expression driving apparatus, including: a processing module; wherein the processing module is configured to:
acquire a first video; and
input the first video into a pre-trained expression driving model to obtain a second video; wherein the expression driving model is trained based on a target sample image and a plurality of first sample images, wherein a facial image in the second video is generated based on the target sample image, and wherein a gesture expression feature of the facial image in the second video is the same as a gesture expression feature of a facial image in the first video.

In some embodiments, the expression driving model is trained based on a plurality of sample image pairs determined based on the plurality of first sample images and corresponding second sample images;
a second sample image is derived based on a plurality of target facial keypoints in the target sample image and a plurality of first facial keypoints in a corresponding first sample image; and
a similarity between a gesture expression feature of a facial image in the second sample image and a gesture expression feature of a facial image in the corresponding first sample image is greater than a preset value.

In some embodiments, the second sample image is obtained based on displacement information between the plurality of target facial keypoints and the plurality of first facial keypoints and a corresponding facial feature map of the target sample image;
for each target facial keypoint, the displacement information is displacement information between the target facial keypoint and a corresponding first facial keypoint; and
the facial feature map is obtained by encoding facial information of the target sample image.

In some embodiments, the displacement information is determined according to difference information between the plurality of target facial keypoints and corresponding first facial keypoints, and a pre-trained network model.

In some embodiments, the difference information is determined according to coordinate information of the target facial keypoint and coordinate information of the corresponding first facial keypoint under a same coordinate system.

In some embodiments, the plurality of first sample images are initial sample images in which a number of sample images for each gesture angle conforms to a predetermined distribution

In a fourth aspect, the present disclosure provides a training apparatus of an expression driving model, including: a processing module, wherein the processing module is configured to:
extract a plurality of target facial keypoints in a target sample image, and a plurality of first facial keypoints in each of a plurality of first sample images, respectively;
determine, for each first sample image and each target facial keypoint, displacement information between a target facial keypoint and a first facial keypoint in the first sample image corresponding to the target facial keypoint;
generate a second sample image according to the displacement information and the target sample image; wherein a similarity between a gesture expression feature of a facial image in the second sample image and a gesture expression feature of a facial image in the target sample image is greater than a preset value;
determine a plurality of sample image pairs according to the plurality of first sample images and corresponding second sample images; and
update model parameters of an initial expression driving model according to the plurality of sample image pairs to obtain the expression driving model.

In some embodiments, the processing module is specifically configured to:
encode facial information in the target sample image to obtain a facial feature map; and
determine the second sample image according to the displacement information and the facial feature map.

In some embodiments, the processing module is specifically configured to:
perform, according to the displacement information, bending transition processing and/or displacement processing on the facial feature map to obtain a processed facial feature map; and
decode the processed facial feature map to obtain the second sample image.

In some embodiments, the processing module is specifically configured to:
determine difference information between the target facial keypoints and first facial keypoints in the first sample image corresponding to the target facial keypoints; and
determine the displacement information according to the difference information and a pre-trained network model.

In some embodiments, the processing module is specifically configured to:
transform the plurality of target facial keypoints and the plurality of first facial keypoints into a same coordinate system; and
determine the difference information between a respective target facial keypoints and a corresponding first facial keypoints according to coordinate information of the respective target facial keypoints and the coordinate information of the corresponding first facial keypoints under the same coordinate system.

In some embodiments, the processing module is further configured to:
acquire a plurality of initial sample images;
determine gesture angles of the plurality of initial sample images; and
determine initial sample images in which a number of sample images for each gesture angle conforms to a predetermined distribution as the plurality of first sample images.

In a fifth aspect, the present disclosure provides an electronic device, including, a processor, and a memory communicatively connected with the processor,
the memory stores computer-executable instructions;
the processor executes the computer-executable instructions stored in the memory to implement the method according to any one of the first aspect and the second aspect.

In a sixth aspect, the present disclosure provides a computer-readable storage medium with computer-executable instructions stored thereon, wherein the computer-executable instructions, when executed by a processor, implement the method of the first aspect and the second aspect.

In a seventh aspect, the present disclosure provides a computer program product, including a computer program, wherein the computer program, when executed by a processor, implements the method of the first aspect and the second aspect.

In an eighth aspect, the present disclosure provides a computer program, wherein the computer program, when executed by a processor, implements the method of the first aspect and the second aspect.

The present disclosure provides an expression driving method and apparatus, a training method and apparatus of an expression driving model. The expression driving method includes: acquiring a first video; and inputting the first video into a pre-trained expression driving model to obtain a second video; wherein the expression driving model is trained based on a target sample image and a plurality of first sample images, wherein a facial image in the second video is generated based on the target sample image, and wherein a gesture expression feature of the facial image in the second video is the same as a gesture expression feature of a facial image in the first video. In the above expression driving method, the expression driving model is trained based on the target sample image and the plurality of first sample images, and in the process of obtaining the second video through the expression driving model, the expression driving model has low computational complexity and can obtain the second video based on the first video in real-time, thereby improving the real-time performance of the second video.

### BRIEF DESCRIPTION OF DRAWINGS

The accompanying drawings, which are incorporated in and constitute a part of the specification, illustrate embodiments consistent with the present disclosure and together with the description, serve to explain the principles of the disclosure.

FIG. 1 is a schematic diagram of an application scenario of an expression driving method provided by the present disclosure;

FIG. 2 is one flowchart of an expression driving method provided by the present disclosure;

FIG. 3 is a flowchart of a training method of an expression driving model provided by the present disclosure;

FIG. 4 is a schematic diagram illustrating multiple target facial keypoints according to the present disclosure;

FIG. 5 illustrates a model structure for obtaining a second sample image in accordance with the present disclosure;

FIG. 6 is a structural diagram of an expression driving apparatus according to the present disclosure;

FIG. 7 is a structural schematic diagram of a training apparatus of an expression driving model provided by the present disclosure;

FIG. 8 is a hardware schematic diagram of an electronic device according to embodiments of the present disclosure.

Specific embodiments of the present disclosure are illustrated by the above-described drawings and will be described in more detail hereinafter. These drawings and description are not intended to limit the scope of the concept of the present disclosure in any way, but rather to illustrate the concept of the present disclosure for those skilled in the art by reference to particular embodiments.

### DETAILED DESCRIPTION

Reference will be made in detail to exemplary embodiments, examples of which are illustrated in the accompanying drawings. Where the following description refers to the drawings, unless otherwise indicated, the same reference numbers in different drawings refer to the same or similar elements. The implementation described in the following exemplary embodiments does not represent all implementation consistent with the present disclosure. Instead, they are merely examples of apparatus and methods consistent with some aspects of the present disclosure as detailed in the following claims.

The terms involved in the present disclosure are first explained:

The character-image driving refers to driving a static character-image according to driving information such as human gestures, facial expressions, and the like, so that the static character-image can be realistically moved.

The real-time driving refers to capturing human gestures, facial expressions, and the like in real time by an imaging device, and driving the static character-image in real time based on the captured human gestures, facial expressions, and the like, so that the static character-image can be realistically moved.

Next, the related art will be described.

In the related art, it is common to employ a generative adversarial networks (GAN) model to process a driving video to obtain driving information, and employ the driving information to drive a static character-image, thereby generating a new video. During obtaining the new video by the generative adversarial network model, since the generative adversarial network model requires a large amount of data computation, the real-time performance of the new video is poor.

In the present disclosure, in order to improve the real-time performance of the new video, the inventor conceives that the driving video and the target picture (including the static character-image) are processed by an expression driving model with a small calculation amount of data to obtain the new video. Since the calculation amount of the expression driving model in the present disclosure is small, the driving video and the target picture can be processed quickly, thereby improving the real-time performance of the new video.

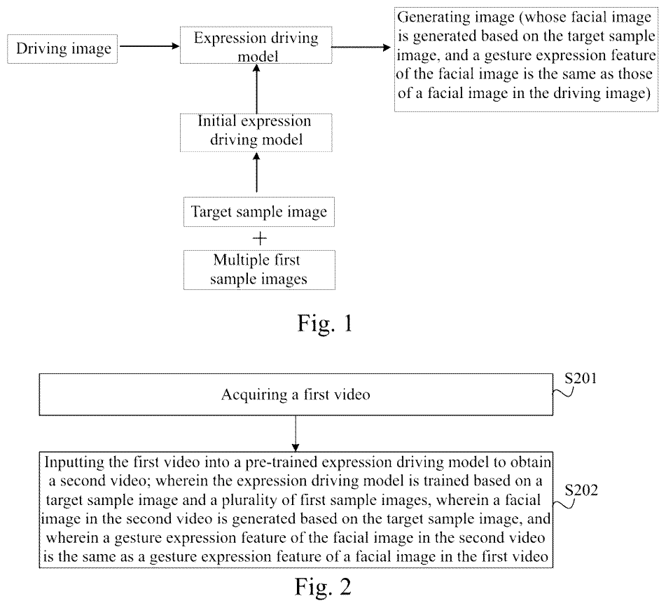

Further, an application scenario of the expression driving method provided by the present disclosure is explained in conjunction with FIG. 1, taking as an example that a driving image is included in a first video (driving video) and a generating image is included in a second video (new video).

FIG. 1 is a schematic diagram of an application scenario of an expression driving method provided by the present disclosure. As shown in FIG. 1, including: a target sample image, a driving image, a generating image, a plurality of first sample images, an expression driving model, an initial expression driving model.

The initial expression driving model is trained based on the target sample image and the plurality of first sample images, resulting in the expression driving model.

The expression driven model is used to process the driving image (one frame of image in a first video) and output a generating image (one frame of image in a second video). A facial image in the generating image is generated based on the target sample image, and a gesture expression feature of the facial image in the generating image and a gesture expression feature of a facial image in the driving image are the same.

The technical solutions of the present disclosure and how the technical solutions of the present disclosure solve the above technical problems are explained in detail below in some embodiments. The following several embodiments may be combined with each other, and the same or similar concepts or processes may not be repeated in the embodiments. Embodiments of the present disclosure will be described below with reference to the accompanying drawings

FIG. 2 is a flowchart one of an expression driving method provided by the present disclosure. As shown in FIG. 2, the method includes:

S201, acquiring a first video.

Alternatively, the execution subject of the present disclosure may be an electronic device, or may be an expression driving apparatus provided in the electronic device, which may be implemented by a combination of software and/or hardware. The electronic device may be an electronic device including a high-performance graphics processing unit (GPU) or an electronic device including a low-performance GPU. Among them, the high-performance GPU is faster in computation speed and the low-performance GPU is slower in computation speed. For example, the electronic device including the low-performance GPU may be a Personal Digital Assistant (PDA), a User Device or User Equipment. For example, the user device may be a smartphone or the like.

Alternatively, the first video may be a video captured in real time by the electronic device or may be a video pre-stored in the electronic device. N frames of driving images are included in the first video. N is an integer greater than or equal to 2.

S202, inputting the first video into a pre-trained expression driving model to obtain a second video; wherein the expression driving model is trained based on a target sample image and a plurality of first sample images, wherein a facial image in the second video is generated based on the target sample image, and wherein a gesture expression feature of the facial image in the second video is the same as a gesture expression feature of a facial image in the first video.

The second video includes N frames of generating images.

For each frame of driving image in the first video, the expression driven model processes the driving image, resulting in a generating image in the second video corresponding to the driving image.

Optionally, the gesture expression feature may include: a gesture angle and an expression.

Optionally, the gesture angle may include at least one of: a pitch angle, a roll angle, a yaw angle. Alternatively, the pitch angle may indicate looking up or looking down. The yaw angle may indicate tilting the head to the left, or tilting the head to the right. The roll angle may indicate that turning the face to the left, or turning the face to the right.

In the expression driving method provided by the embodiments in FIG. 2, the expression driving model is trained based on the target sample image and the plurality of first sample images, and in the process of obtaining the second video through the expression driving model, the data calculation amount of the expression driving model is small, and the second video can be obtained in real time based on the first video, thereby improving the real-time performance of the second video.

Further, in the related art, the data computation amount of the generative adversarial network model is large, so that only the generative adversarial network model can be deployed in an electronic device with a high-performance GPU so that the new video has better real-time performance, when the generative adversarial network model is deployed in an electronic device with a low-performance GPU so that the new video has problems such as stuttering, resulting in poor real-time performance of the new video. Different from the related art, in the present disclosure, the data computation amount of the expression driving model is small (i.e., the computation of the generator is small), even if the expression driving model is deployed in an electronic device with a low-performance GPU, the second video can have a better real-time performance.

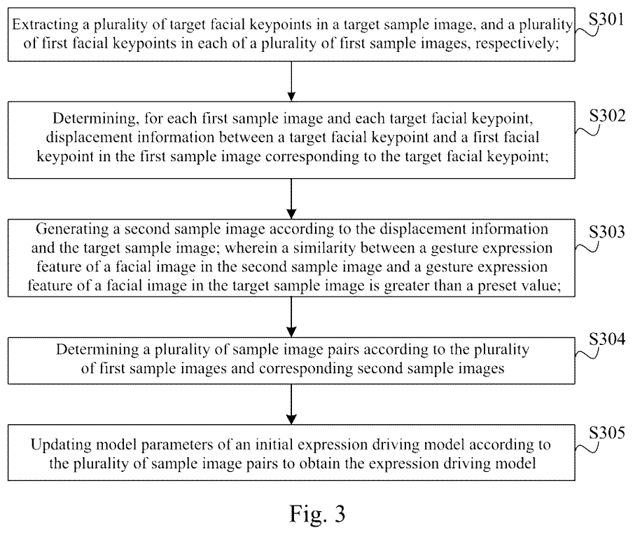

On the basis of the above embodiments, the training method of the expression driving model is explained below in conjunction with FIG. 3, in particular, embodiments of FIG. 3 can be referred to.

FIG. 3 is a flowchart of a training method of an expression driving model provided by the present disclosure As shown in FIG. 3, the method includes:

S301, extracting a plurality of target facial keypoints in a target sample image, and a plurality of first facial keypoints in each of a plurality of first sample images, respectively

Alternatively, the execution subject of the training method of the expression driving model may be an electronic device, or a training apparatus of the expression driving model provided in the electronic device, or a server communicated with the electronic device, or a training apparatus of the expression driving model provided in the server, and the training apparatus of the expression driving model may be implemented by a combination of software and/or hardware.

Alternatively, the target sample image may be a pre-set image or may be a user-selected image among at least one pre-set image. Therein, each preset image includes a static character-image (including a human face). For example, the static character-image may be a cartoon character-image, a character image in a classic portrait, or the like.

Alternatively, the plurality of target facial keypoints in the target sample image may be extracted by the following solution 11 and solution 12.

Solution 11, performing keypoints extraction on the target sample image by a facial keypoint detection algorithm model to obtain a plurality of facial keypoints and corresponding position information;
performing keypoints extraction on the target sample image by a pupil keypoint detection algorithm model to obtain a plurality of pupil keypoints and corresponding position information;
performing keypoints extraction on the target sample image by a facial contour keypoint detection algorithm model to obtain a plurality of facial contour keypoints and corresponding position information; and
determining multiple target facial keypoints according to the plurality of facial keypoints, the plurality of pupil keypoints, and the plurality of facial contour keypoints.

Alternatively, keypoints corresponding to the four parts of the nose, the mouth, the eyes, and the eyebrows among the plurality of facial keypoints, as well as the plurality of pupil keypoints and the plurality of facial contour keypoints may be determined as the multiple target facial keypoints.

Alternatively, keypoints corresponding to the five parts of the nose, the mouth, the eyes, the eyebrows, and an outline of a face (an outline of a lower half face) among the plurality of facial keypoints, as well as the plurality of pupil keypoints, and keypoints corresponding to an outline of an upper half face among the plurality of facial contour keypoints may be determined as the multiple target facial keypoints.

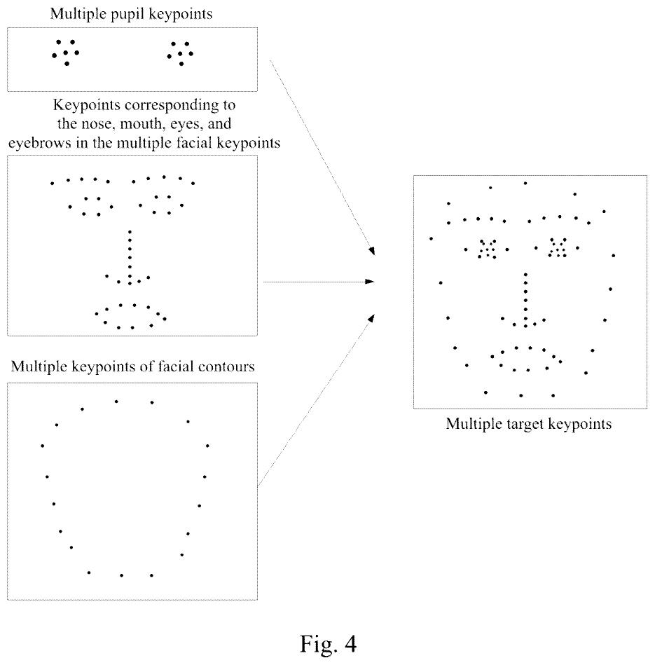

FIG. 4 is a schematic diagram illustrating a plurality of target facial keypoints according to the present disclosure. On the basis of the above-described solution 11, as shown in FIG. 4, the plurality of target keypoints include, for example, keypoints corresponding to the four parts of the nose, the mouth, the eyes, and the eyebrows among the plurality of facial keypoints, as well as the plurality of pupil keypoints, and the plurality of facial contour keypoints.

Solution 12: performing keypoints extraction on the target sample image by a facial keypoint detection algorithm model to obtain a plurality of facial keypoints and corresponding position information;
performing keypoints extraction on the target sample image by a pupil keypoint detection algorithm model to obtain a plurality of pupil keypoints and corresponding position information;
performing keypoints extraction on the target sample image by a dense keypoint detection algorithm model of mouth to obtain a plurality of mouth keypoints and corresponding position information;
performing keypoints extraction on the target sample image by a facial contour keypoint detection algorithm model to obtain a plurality of facial contour keypoints and corresponding position information; and
determining multiple target facial keypoints according to the plurality of facial keypoints, the plurality of pupil keypoints, the plurality of mouth keypoints, and the plurality of facial contour keypoints.

Alternatively, keypoints corresponding to the three parts of the nose, the eyes, and the eyebrows among the plurality of facial keypoints, as well as the plurality of pupil keypoints, the plurality of mouth keypoints, and the plurality of facial contour keypoints, may be determined as the plurality of target facial keypoints.

Alternatively, keypoints corresponding to the four parts of the nose, the eyes, the eyebrows, and an outline of a face (an outline of a lower half face) among the plurality of facial keypoints, as well as the plurality of pupil keypoints, the plurality of mouth keypoints, and keypoints corresponding to an outline of an upper half face among the plurality of facial contour keypoints may be determined as the multiple target facial keypoints.

It should be noted that for each first sample image, the plurality of first facial keypoints in the first sample image may be extracted in the above-described solution 11 or solution 12, which will not be described in detail here.

S302, determining, for each first sample image and each target facial keypoint, displacement information between a target facial keypoint and a first facial keypoint in the first sample image corresponding to the target facial keypoint.

In some embodiments, S302 specifically includes: determining difference information between the target facial keypoints and first facial keypoints in the first sample image corresponding to the target facial keypoints, and
determining the displacement information according to the difference information and a pre-trained network model.

In some embodiments, the difference information may be determined by:
transforming the plurality of target facial keypoints and the plurality of first facial keypoints into a same coordinate system; and
determining the difference information between a respective target facial keypoints and a corresponding first facial keypoints according to coordinate information of the respective target facial keypoints and the coordinate information of the corresponding first facial keypoints under the same coordinate system.

Optionally, for each target facial keypoint, the difference information may be equal to a difference value of the coordinate information of the target facial keypoint and the coordinate information of the first facial keypoint corresponding to the target facial keypoint.

In some embodiments, converting the plurality of target facial keypoints and the plurality of first facial keypoints into the same coordinate system includes: converting the position information of each target facial keypoint and the position information of each first facial keypoint into the same coordinate system.

In some embodiments, the difference information between each target facial keypoint and the corresponding first facial keypoint is processed through a pre-trained network model to obtain the displacement information.

S303, generating a second sample image according to the displacement information and the target sample image; wherein a similarity between a gesture expression feature of a facial image in the second sample image and a gesture expression feature of a facial image in the target sample image is greater than a preset value.

In some embodiments, S303 specifically includes: adjusting positions of the respective target keypoints in the target sample image according to the displacement information to obtain the second sample image.

In other some embodiments, S303 specifically includes: encoding facial information in the target sample image to obtain a facial feature map; and determining the second sample image according to the displacement information and the facial feature map.

Specifically, determining the second sample image according to the displacement information and the facial feature map includes: performing, according to the displacement information, bending transition processing and/or displacement processing on the facial feature map to obtain a processed facial feature map; and decoding the processed facial feature map to obtain the second sample image.

S304, determining a plurality of sample image pairs according to the plurality of first sample images and corresponding second sample images.

Each sample image pair includes a first sample image and a second sample image to which the first sample image corresponds.

The first sample image in the plurality of sample image pairs is different.

S305, updating model parameters of an initial expression driving model according to the plurality of sample image pairs to obtain the expression driving model.

Optionally, the initial expression driving model can include a generator and a discriminator. Specifically, the model parameters of the generator and the discriminator are updated based on the plurality of sample image pairs to obtain the expression driving model. The expression driving model is the final model of the generator after updating the model parameters of the generator.

Optionally, the expression driving model is obtained when the number of times of updating the model parameters of the initial expression driving model reaches a pre-set number of times, or the training duration on the initial expression driving model reaches a preset duration, or the model parameters of the initial expression driving model are convergent.

The initial expression driven model is typically trained using a plurality of sample image pairs, e.g., one sample image pair including an image A and an image B, in which, a gesture expression feature of a facial image in the image B and a gesture expression feature of a facial image in the image A.

In the related art, image B is typically drawn manually, resulting in multiple sample image pairs that are difficult to acquire, wasting human and time costs. Whereas in the present disclosure, a plurality of target facial keypoints in the target sample image, and a plurality of first facial keypoints in each of the plurality of first sample images are extracted respectively; for each first sample image and each target facial keypoint, displacement information between the target facial keypoint and a first facial keypoint in the first sample image corresponding to the target facial keypoint is determined, and the second sample image is generated based on the displacement information and the target sample image, it can avoid drawing the second sample image corresponding to the first sample image manually, thus, the labor cost and the time cost are reduced.

On the basis of the embodiment of FIG. 3, the training method of the expression driven model may further include:
acquiring a plurality of initial sample images;
determining gesture angles of the plurality of initial sample images; and
determining initial sample images in which a number of sample images for each gesture angle conforms to a predetermined distribution as the plurality of first sample images.

In some embodiments, determining gesture angles of the plurality of initial sample images includes: detecting a rotation angle of each initial sample image separately to obtain the gesture angle of each initial sample image.

Alternatively, the predetermined distribution may be a uniform distribution, but may also be another distribution, which is not described in detail herein.

In practical applications, where the plurality of first sample images typically includes multiple facial images (with a certain fixed gesture angle), if the initial expression driving model is trained with the plurality of first sample images including multiple facial images, this will result in an expression driving model with less accurate, which in turn degrades the quality of the new video. In the present disclosure, initial sample images in which a number of sample images for each gesture angle conforms to a predetermined distribution are determined as the plurality of first sample images, such that the number of sample images having various gesture angles among the plurality of first sample images is more balanced (i.e., the gesture angle distribution of the plurality of first sample images is more balanced), thus, after the initial expression driving model is trained by the plurality of first sample images, the accuracy of the expression driving model can be improved, and thus the quality of the second video can be improved.

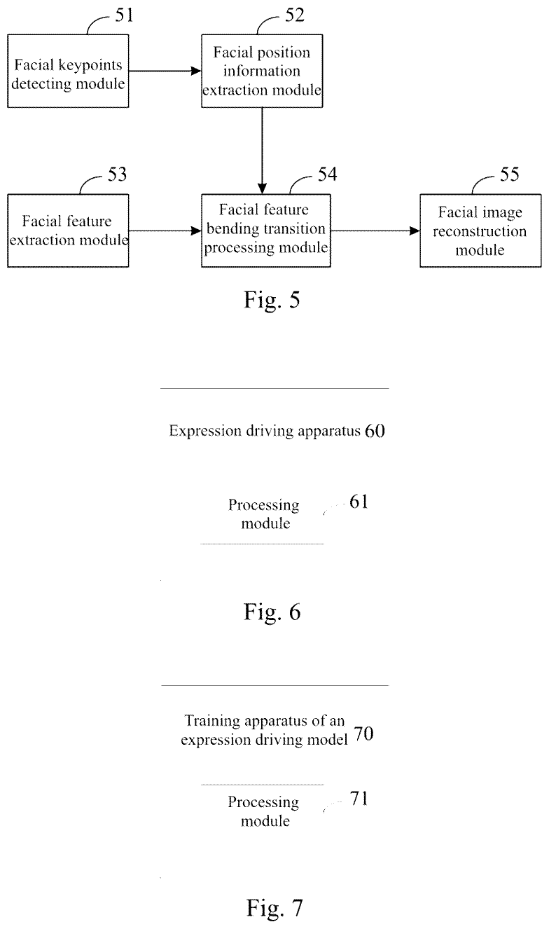

FIG. 5 illustrates a model structure for obtaining a second sample image in accordance with the present disclosure. As shown in FIG. 5, the model structure includes:

A facial keypoint detection module 51, a facial position information extraction module 52, a facial feature extraction module 53, a facial feature bending transition processing module 54 and a facial image reconstruction module 55.

The facial feature bending transition processing module 54 is connected with the facial position information extraction module 52, the facial feature extraction module 53, the facial image reconstruction module 55, and the facial position information extraction module 52 is further connected with the facial keypoint detection module 51.

The facial keypoint detection module 51 is configured to extract a plurality of target facial keypoints in a target sample image, and a plurality of first facial keypoints in each of a plurality of first sample images, respectively.

The facial position information extracting module 52 is configured to determine, for each first sample image and each target facial keypoint, displacement information between a target facial keypoint and a first facial keypoint in the first sample image corresponding to the target facial keypoint.

The facial feature extraction module 53 is configured to encode facial information in the target sample image to obtain a facial feature map.

The facial feature bending transition processing module 54 is configured to perform, according to the displacement information, bending transition processing and/or displacement processing on the facial feature map to obtain a processed facial feature map.

The facial image reconstruction module 55 is configured to decode the processed facial feature map to obtain the second sample image.

FIG. 6 is a structural diagram of an expression driving apparatus according to the present disclosure. As shown in FIG. 6, the expression driving apparatus 60 includes: a processing module 61. The processing module 61 is configured to:
acquiring a first video; and
input the first video into a pre-trained expression driving model to obtain a second video; wherein the expression driving model is trained based on a target sample image and a plurality of first sample images, wherein a facial image in the second video is generated based on the target sample image, and wherein a gesture expression feature of the facial image in the second video is the same as a gesture expression feature of a facial image in the first video.

The expression driving apparatus 60 provided by the embodiments of the present disclosure can perform the above expression driving method, its implementation principles as well as beneficial effects are similar, which will not be repeated here.

In some embodiments, the expression driving model is trained by a plurality of sample image pairs which are determined based on a plurality of first sample images and corresponding second sample images;
a second sample image is derived based on a plurality of target facial keypoints in the target sample image and a plurality of first facial keypoints in a corresponding first sample image; and
a similarity between a gesture expression feature of a facial image in the second sample image and a gesture expression feature of a facial image in the corresponding first sample image is greater than a preset value.

In some embodiments, the second sample image is obtained based on displacement information between the plurality of target facial keypoints and the plurality of first facial keypoints and a corresponding facial feature map of the target sample image;
for each target facial keypoint, the displacement information is displacement information between the target facial keypoint and a corresponding first facial keypoint; and
the facial feature map is obtained by encoding facial information of the target sample image.

In some embodiments, the displacement information is determined according to difference information between the plurality of target facial keypoints and corresponding first facial keypoints, and a pre-trained network model.

In some embodiments, the difference information is determined according to coordinate information of the target facial keypoint and coordinate information of the corresponding first facial keypoint under a same coordinate system.

In some embodiments, the plurality of first sample images are initial sample images in which a number of sample images for each gesture angle conforms to a predetermined distribution.

FIG. 7 is a structural diagram of a training apparatus of an expression driving model provided by the present disclosure. As shown in FIG. 7, the training apparatus of the expression driving model 70 includes: a processing module 71. The processing module 71 is configured to:
extract a plurality of target facial keypoints in a target sample image, and a plurality of first facial keypoints in each of a plurality of first sample images, respectively;
determine, for each first sample image and each target facial keypoint, displacement information between a target facial keypoint and a first facial keypoint in the first sample image corresponding to the target facial keypoint;
generate a second sample image according to the displacement information and the target sample image; wherein a similarity between a gesture expression feature of a facial image in the second sample image and a gesture expression feature of a facial image in the target sample image is greater than a preset value;
determine a plurality of sample image pairs according to the plurality of first sample images and corresponding second sample images; and
update model parameters of an initial expression driving model according to the plurality of sample image pairs to obtain the expression driving model 1.

The training apparatus of the expression driving model 70 provided by the embodiments of the present disclosure may perform the training method of the expression driving model described above, and its implementation principles and beneficial effects are similar, which will not be repeated here.

In some embodiments, the processing module 71 is specifically configured to:
encode facial information in the target sample image to obtain a facial feature map; and
determine the second sample image according to the displacement information and the facial feature map.

In some embodiments, the processing module 71 is specifically configured to:
perform, according to the displacement information, bending transition processing and/or displacement processing on the facial feature map to obtain a processed facial feature map; and
decode the processed facial feature map to obtain the second sample image.

In some embodiments, the processing module 71 is specifically configured to:
determine difference information between the target facial keypoints and first facial keypoints in the first sample image corresponding to the target facial keypoints; and
determine the displacement information according to the difference information and a pre-trained network model.

In some embodiments, the processing module 71 is specifically configured to:
transform the plurality of target facial keypoints and the plurality of first facial keypoints into a same coordinate system; and
determine the difference information between a respective target facial keypoints and a corresponding first facial keypoints according to coordinate information of the respective target facial keypoints and the coordinate information of the corresponding first facial keypoints under the same coordinate system.

In some embodiments, the processing module 71 is further configured to:
acquire a plurality of initial sample images;
determine gesture angles of the plurality of initial sample images; and
determine initial sample images in which a number of sample images for each gesture angle conforms to a predetermined distribution as the plurality of first sample images.

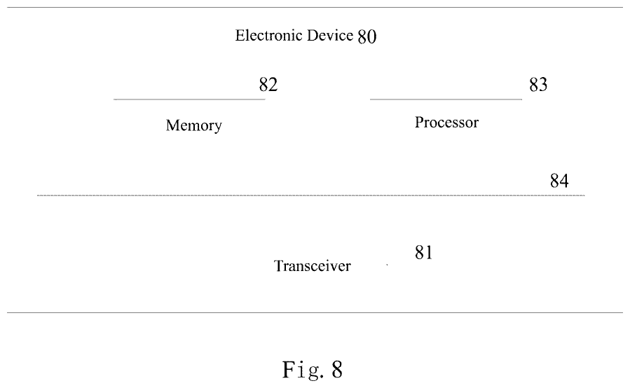

FIG. 8 is a hardware schematic diagram of an electronic device according to embodiments of the present disclosure. As shown in FIG. 8, the electronic device 80 may include a transceiver 81, a memory 82, and a processor 83.

Therein, the transceiver 81 may include: a transmitter and/or a receiver. A transmitter may also be referred to as a sending device, transmission device, transmission port or transmission interface, and like descriptions. The receiver may also be referred to as a receiving device, receive port, or receive interface, among similar descriptions.

Exemplarily, portions of the transceiver 81, the memory 82, the processor 83 are interconnected by a bus 84.

The memory 82 is used to store computer executable instructions.

The processor 83 is configured to execute the computer-executable instructions stored in the memory 82, so that the processor 83 performs the above-described expression driving method, and the training method of the expression driving model.

Embodiments of the present disclosure provides a computer-readable storage medium with computer-executable instructions stored thereon, which, when executed by a processor, implement the above-mentioned expression driving method, and the training method of an expression driving model.

Embodiments of the present disclosure also provides a computer program product including a computer program which, when executed by a processor, can implement the above-described expression driving method and the training method of an expression driving model.

Embodiments of the present disclosure further provides a computer program which, when executed by a processor, implements the above-described expression driving method and the training method of an expression driving model.

All or part of the steps of implementing the above-described method embodiments may be carried out by hardware associated with program instructions. The aforementioned program may be stored in a readable memory. The program, when executed, performs steps including the above-described method embodiments. The aforementioned memory (storage medium) includes read-only memory (ROM), random access memory (RAM), flash memory, hard disk, solid state drive, magnetic tape, floppy disk, optical disc, and any combination thereof.

Embodiments of the present disclosure are described with reference to flowchart illustrations and/or block diagrams of methods, apparatus (systems), and computer program products according to embodiments of the present disclosure. It should be understood that each flow and/or block in the flowchart illustrations and/or block diagrams, and combinations of the flows and/or blocks in the flowchart illustrations and/or block diagrams can be realized by computer program instructions. These computer program instructions may be provided to a processing unit of a general-purpose computer, a special purpose computer, an embedded processor, or other programmable data processing devices for producing a machine, such that the instructions, which are executed by the processing unit of the computer or other programmable data processing devices, produce apparatus means for implementing the functions specified in the flowchart flow or flows and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including apparatus instructions which implement the functions specified in the flowchart process or processes and/or block diagram block or blocks.

These computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart process or processes and/or block diagram block or blocks.

It will be apparent to those skilled in the art that various modifications and variations can be made to the disclosed embodiments without departing from the spirit and scope of the present disclosure. Thus, the present disclosure is intended to cover such modifications and variations of the embodiments of the present disclosure provided they come within the scope of the claims of the present disclosure and their equivalents.

In this disclosure, the term “include” and variations thereof may refer to non-limiting inclusion; The term “or” and its variants may mean “and/or.” The terms “first”, “second”, and the like in this disclosure are used for distinguishing between similar objects and not necessarily for describing a particular sequential or chronological order. In the present disclosure, a “plurality” means two or more than two. “And/or”, describing an association relationship of an associated object, means that three kinds of relationships may exist, for example, A and/or B may mean that there are three situations: A exists alone, A and B exist simultaneously, and B exists alone. The character “/” generally indicates that the contextual object is an “or” relationship.

Other embodiments of the disclosure will be apparent to those skilled in the art from consideration of the specification and practice of the invention disclosed herein. This disclosure is intended to cover any variations, uses, or adaptations of the disclosure following the general principles of the disclosure and including common general knowledge or customary practice in the art to which the disclosure is not disclosed. It is intended that the specification and examples be considered as exemplary only, with a true scope and spirit of the disclosure being indicated by the following claims.

It should be understood that the present disclosure is not limited to the precise construction that has been described above and illustrated in the accompanying drawings, and that various modifications and changes may be made without departing from the scope thereof. The scope of the present disclosure is limited only by the following claims.

1. An expression driving method, comprising:
acquiring a first video; and
inputting the first video into a pre-trained expression driving model to obtain a second video; wherein the expression driving model is trained based on a target sample image and a plurality of first sample images, wherein a facial image in the second video is generated based on the target sample image, and wherein a gesture expression feature of the facial image in the second video is the same as a gesture expression feature of a facial image in the first video.

2. The method of claim 1, wherein the expression driving model is trained based on a plurality of sample image pairs determined based on the plurality of first sample images and corresponding second sample images;
a second sample image is derived based on a plurality of target facial keypoints in the target sample image and a plurality of first facial keypoints in a corresponding first sample image; and
a similarity between a gesture expression feature of a facial image in the second sample image and a gesture expression feature of a facial image in the corresponding first sample image is greater than a preset value.

3. The method of claim 2, wherein the second sample image is obtained based on displacement information between the plurality of target facial keypoints and the plurality of first facial keypoints and a corresponding facial feature map of the target sample image;
for each target facial keypoint, the displacement information is displacement information between the target facial keypoint and a corresponding first facial keypoint; and
the facial feature map is obtained by encoding facial information of the target sample image.

4. The method of claim 3, wherein the displacement information is determined according to difference information between the plurality of target facial keypoints and corresponding first facial keypoints, and a pre-trained network model.

5. The method of claim 4, wherein the difference information is determined according to coordinate information of the target facial keypoint and coordinate information of the corresponding first facial keypoint under a same coordinate system.

6. The method of claim 1, wherein the plurality of first sample images are initial sample images in which a number of sample images for each gesture angle conforms to a predetermined distribution.

7. A training method of an expression driving model, comprising:
extracting a plurality of target facial keypoints in a target sample image, and a plurality of first facial keypoints in each of a plurality of first sample images, respectively;
determining, for each first sample image and each target facial keypoint, displacement information between a target facial keypoint and a first facial keypoint in the first sample image corresponding to the target facial keypoint;
generating a second sample image according to the displacement information and the target sample image; wherein a similarity between a gesture expression feature of a facial image in the second sample image and a gesture expression feature of a facial image in the target sample image is greater than a preset value;
determining a plurality of sample image pairs according to the plurality of first sample images and corresponding second sample images; and
updating model parameters of an initial expression driving model according to the plurality of sample image pairs to obtain the expression driving model.

8. The method of claim 7, wherein the generating the second sample image according to the displacement information and the target sample image comprises:
encoding facial information in the target sample image to obtain a facial feature map; and
determining the second sample image according to the displacement information and the facial feature map.

9. The method of claim 8, wherein the determining the second sample image according to the displacement information and the facial feature map comprises:
performing, according to the displacement information, bending transition processing and/or displacement processing on the facial feature map to obtain a processed facial feature map; and
decoding the processed facial feature map to obtain the second sample image.

10. The method of claim 7, wherein the determining displacement information between the target facial keypoint and the first facial keypoint in the first sample image corresponding to the target facial keypoint comprises:
determining difference information between the target facial keypoints and first facial keypoints in the first sample image corresponding to the target facial keypoints; and
determining the displacement information according to the difference information and a pre-trained network model.

11. The method of claim 10, wherein the determining the difference information between the target facial keypoints and first facial keypoints in the first sample image corresponding to the target facial keypoints comprises:
transforming the plurality of target facial keypoints and the plurality of first facial keypoints into a same coordinate system; and
determining the difference information between a respective target facial keypoints and a corresponding first facial keypoints according to coordinate information of the respective target facial keypoints and the coordinate information of the corresponding first facial keypoints under the same coordinate system.

12. The method of claim 7, further comprising:
acquiring a plurality of initial sample images;
determining gesture angles of the plurality of initial sample images; and
determining initial sample images in which a number of sample images for each gesture angle conforms to a predetermined distribution as the plurality of first sample images.

13. (canceled)

14. (canceled)

15. An electronic device, comprising: a processor and a memory communicatively connected with the processor, wherein
the memory stores computer-executable instructions; and
wherein the computer-executable instructions, upon execution of the processor, cause the processor to:
acquire a first video; and
input the first video into a pre-trained expression driving model to obtain a second video; wherein the expression driving model is trained based on a target sample image and a plurality of first sample images, wherein a facial image in the second video is generated based on the target sample image, and wherein a gesture expression feature of the facial image in the second video is the same as a gesture expression feature of a facial image in the first video.

16. A non-transitory computer-readable storage medium with computer-executable instructions stored thereon, wherein the computer-executable instructions, when executed by a processor, cause the processor to implement the steps of the expression driving method according to claim 1.

17. (canceled)

18. (canceled)

19. The electronic device of claim 15, wherein the expression driving model is trained based on a plurality of sample image pairs determined based on the plurality of first sample images and corresponding second sample images;
a second sample image is derived based on a plurality of target facial keypoints in the target sample image and a plurality of first facial keypoints in a corresponding first sample image; and
a similarity between a gesture expression feature of a facial image in the second sample image and a gesture expression feature of a facial image in the corresponding first sample image is greater than a preset value.

20. The electronic device of claim 19, wherein the second sample image is obtained based on displacement information between the plurality of target facial keypoints and the plurality of first facial keypoints and a corresponding facial feature map of the target sample image;
for each target facial keypoint, the displacement information is displacement information between the target facial keypoint and a corresponding first facial keypoint; and
the facial feature map is obtained by encoding facial information of the target sample image.

21. The electronic device of claim 20, wherein the displacement information is determined according to difference information between the plurality of target facial keypoints and corresponding first facial keypoints, and a pre-trained network model.

22. The electronic device of claim 21, wherein the difference information is determined according to coordinate information of the target facial keypoint and coordinate information of the corresponding first facial keypoint under a same coordinate system.

23. An electronic device, comprising: a processor and a memory communicatively connected with the processor, wherein
the memory stores computer-executable instructions; and
wherein the computer-executable instructions, upon execution of the processor, cause the processor to implement the steps of the training method of an expression driving model according to claim 7.

24. A non-transitory computer-readable storage medium with computer-executable instructions stored thereon, wherein the computer-executable instructions, when executed by a processor, cause the processor to implement the steps of the training method of an expression driving model according to claim 7.
